(19) United States
(12) Patent Application Publication
(10) Pub. No.: US 2025/0251355 A1
(43) Pub. Date: Aug. 7, 2025

(54) SEMICONDUCTOR INSPECTION APPARATUS, SEMICONDUCTOR INSPECTION SYSTEM AND SEMICONDUCTOR INSPECTION METHOD

(71) Applicant: Rigaku Corporation, Tokyo (JP)

(72) Inventors: Kazuhiko OMOTE, Tokyo (JP); Raita HIROSE, Tokyo (JP); Shuichi KATO, Tokyo (JP); Yuriy PLATONOV, Auburn Hills, MI (US)

(73) Assignee: Rigaku Corporation, Tokyo (JP)

(21) Appl. No.: 18/856,882

(22) PCT Filed: Feb. 21, 2023
(86) PCT No.: PCT/JP2023/006167

§ 371 Date: Oct. 15, 2024

(30) Foreign Application Priority Data
Apr. 22, 2022 (JP) 2022-071044

(51) Int. Cl. G01N 23/083

(52) U.S. Cl. CPC G01N 23/083; G01N 2223/1016; G01N 2223/306; G01N 2223/309; G01N 2223/32; G01N 2223/6116

(57) ABSTRACT

A semiconductor inspection apparatus, semiconductor inspection system, and semiconductor inspection method capable of locally inspecting a microstructure inside a semiconductor by obtaining an enlarged image with sufficient intensity with a size that can be stored in a laboratory are provided. A semiconductor inspection apparatus using an enlarged X-ray image comprises an X-ray source having a micro focus and high output, an X-ray irradiation unit having a condenser mirror for condensing and irradiating emitted X-rays toward a sample of semiconductor, a sample holder for holding the sample, a reflecting mirror type X-ray lens unit for forming an image with an X-ray transmitted through the sample and an imaging unit for acquiring the formed X-ray image, and each mirror constituting the condenser mirror and the reflecting mirror type X-ray lens unit has a reflective surface that is formed of a multilayer film having a high reflectivity for X-rays with a specific wavelength.

### RELATED ART

### Field of the Invention

The present invention relates to a semiconductor inspection apparatus, semiconductor inspection system and semiconductor inspection method using an enlarged X-ray image.

### Description of the Related Art

In recent years, semiconductor circuits have been highly integrated, and semiconductors in which fine structures in a direction parallel to a surface are formed deeper in the thickness direction have been developed. Such a surface structure and an inner structure processed by etching of a semiconductor have become difficult to be inspected by conventional optical inspection methods, CD-SEM (Critical Dimension Scanning Electron Microscope) or the like. Therefore, when an attempt is made to inspect the shapes and dimensions of holes that are long in the thickness direction, an inspection with destruction such as a cross-sectional SEM, a TEM, or the like has been required. However, a non-destructive inspection method is strongly required for the management of the semiconductor manufacturing process. One of the methods is to analyze the structure from the pattern of small angle scattered X-rays in the average structure of the region of about several hundred micrometers in diameter by transmission SAXS. However, even if the averaged structure can be inspected by such a method, defects in each structure cannot be inspected by a microscope or the like.

In a conventional imaging type X-ray microscope, a Fresnel zone plate lens (FZP) is often used for an imaging system (for example, see Patent Document 1). However, when FZP is applied to high-energy X-rays, it is difficult to increase the aspect ratio, and the diffraction efficiency is significantly reduced. For example, when X-rays with 15 keV or more are imaged by FZP, the efficiency becomes several percent or less. Further, the numerical aperture (NA) in the case is also 1×10⁻³ or less and is very small. Therefore, it has been difficult to realize a high-resolution X-ray microscope using high-energy X-rays in a laboratory.

In contrast, an X-ray microscope using a Kirkpatrick-Baez mirror (KB mirror) with a size enable to be carried into a room has been developed (e.g., see Patent Document 2). In the X-ray microscope described in Patent Document 2, an imaging system is configured using a KB mirror having a reflection concave surface and a KB mirror having a reflection convex surface. As a result, the rear focal length of the optical system is shortened while the magnification ratio being maintained.

### PATENT DOCUMENTS

Patent Document 1: U.S. Pat. No. 7,394,890
Patent Document 2: JP Patent No. 6478433

In the field of semiconductor manufacturing, at the present, semiconductor devices have been developed in which structure with the size of several tens of nm in a direction parallel to the surface is formed in a depth direction over several micrometers or more. However, by the conventional inspection apparatus, even a complicated structure inside the deep hole structure cannot be inspected in a non-destructive manner.

In the X-ray microscope described in Patent Document 2, the angle of incidence must be limited below the critical angle since the total reflection of X-rays is used, and thus it is necessary to increase the length in the X-ray beam direction in order to realize a lens with large numerical aperture. Especially, in application field of X ray microscopes, it is required that X-ray microscope can image with high efficiency even in the X-ray of high energy in the size which can be installed in the laboratory.

### SUMMARY OF THE INVENTION

The present invention has been made in view of such circumstances, and an object of the present invention semiconductor inspection apparatus, is to provide a semiconductor inspection system, and semiconductor inspection method capable of locally inspecting a microstructure inside a semiconductor by acquiring an enlarged image with sufficient intensity with a size that can be stored in a laboratory.

(1) In order to achieve the above object, the semiconductor inspection apparatus of the present invention is a semiconductor inspection apparatus using an enlarged X-ray image, comprising an X-ray source having a micro focus and high output, an X-ray irradiation unit having a condenser mirror for condensing and irradiating emitted X-rays toward a sample of semiconductor, a sample holder for holding the sample, a reflecting mirror type X-ray lens unit for forming an image with an X-ray transmitted through the sample, and an imaging unit for acquiring the formed X-ray image, wherein each mirror constituting the condenser mirror and the reflecting mirror type X-ray lens unit has a reflective surface that is formed of a multilayer film having a high reflectivity for X-rays with a specific wavelength.

(2) Further, in the semiconductor inspection apparatus according to (1), the sample comprises a substrate forming a semiconductor circuit, and a semiconductor device layer provided on the substrate.

(3) Further, in the semiconductor inspection apparatus according to (1) or (2), the sample is a plate-like body having a thickness of 500 μm or more.

(4) Further, in the semiconductor-inspection apparatus according to any one of (1) to (3), a distance on an optical axis from the sample to a receiving surface of the imaging unit is 3 m or less.

(5) Further, in the semiconductor-inspecting device according to any one of (1) to (4), a capture angle by the reflecting mirror type X-ray lens unit is 5 mrad or more.

(6) Further, in the semiconductor inspection apparatus according to any one of (1) to (5), further comprising a position adjustment mechanism capable of adjusting a relative position of the sample with respect to each unit under automatic or operation-based control.

(7) Further, the semiconductor inspection system of the present invention comprises the semiconductor inspection apparatus according to any one of (1) to (6), and a control apparatus connected to the semiconductor inspection apparatus, wherein the control apparatus, automatically or based on an instruction from a user, adjusts a relative position of the sample with respect to each unit in the semiconductor inspection apparatus.

(8) Further, the semiconductor inspection system of the present invention comprises the semiconductor inspection apparatus according to any one of (1) to (6), and an analysis apparatus connected to the semiconductor inspection apparatus, wherein the analysis apparatus quantitatively evaluates surface density of substance at each position based on an absorption coefficient in an X-ray image acquired by the semiconductor inspection apparatus.

(9) Further, the semiconductor inspection system of the present invention comprises the semiconductor inspection apparatus according to (1) or (2), and an analysis apparatus connected to the semiconductor inspection apparatus, wherein the analysis apparatus evaluates a structure of a hole formed in the sample based on an absorption coefficient in an X-ray image acquired by the semiconductor inspection apparatus.

(10) Further, in the semiconductor inspection system according to (9), the X-ray image is measured by tilting the sample.

(11) Further, the semiconductor inspection method of the present invention is a semiconductor inspection method which is performed in a non-destructive manner using the semiconductor inspection apparatus according to any one of (1) to (6), and comprises the steps of: placing the sample in the sample holder, irradiating the sample with an X-ray with 15 keV or more and evaluating the presence or absence of a defect in the sample by the formed X-ray image.

### BRIEF DESCRIPTION OF THE DRAWINGS

FIG. 1 is a schematic view showing an imaging type X-ray microscope.

FIGS. 2A and 2B are plan and front views of the optical system of an imaging type X-ray microscope, respectively.

FIG. 3 is a schematic view showing a convergent angle and a capture angle.

FIG. 4 is a cross-sectional view showing a multilayer film.

FIGS. 5A and 5B are plan views showing a mirror set of vertical reflection and a mirror set of horizontal reflection, respectively.

FIG. 6 is a graph showing the designed value and the measured value of the period length of the multilayer film with respect to the position of the first imaging mirror for vertical reflection.

FIG. 7 is a graph showing the designed value and the measured value of the period length of the multilayer film with respect to the position of the second imaging mirror for vertical reflection.

FIG. 8 is a graph showing the designed value and the measured value of the period length of the multilayer film with respect to the position of the first imaging mirror for horizontal reflection.

FIG. 9 is a graph showing the designed value and the measured value of the period length of the multilayer film with respect to the position of the second imaging mirror for horizontal reflection.

FIG. 10 is a graph showing the magnitude of the error for the surface shape with respect to the position of the second imaging mirror for horizontal reflection.

FIGS. 11A and 11B are diagrams showing X-ray images of 50 nmL&S chart and 50 nm star chart, respectively.

FIGS. 12A and 12B are diagrams showing the X-ray image of 100 nm hole chart and the intensity profile of a part thereof, respectively.

FIG. 13 is a schematic view showing an application example of the imaging type X-ray microscope of the present invention to a semiconductor inspection apparatus.

FIG. 14 a block diagram showing the semiconductor inspection system of the present invention.

### DETAILED DESCRIPTION OF THE INVENTION

Next, embodiments of the present invention are described with reference to the drawings. To facilitate understanding of the description, the same reference numerals are assigned to the same components in the respective drawings, and duplicate descriptions are omitted.

The imaging type X-ray microscope described below can be used in the semiconductor inspection apparatus of the present invention. First, an imaging type X-ray microscope is described, and its application to semiconductor inspection is described later.

### [Imaging Type X-Ray Microscope]

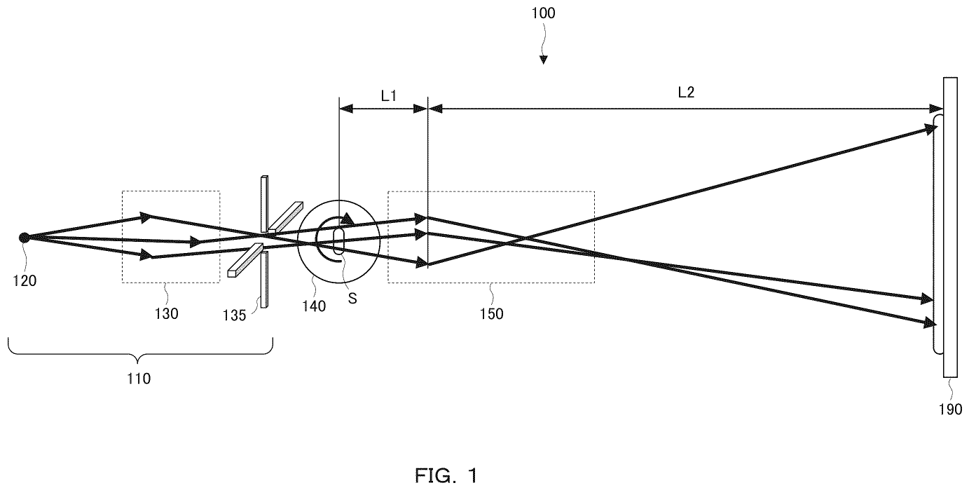

FIG. 1 is a schematic view of an imaging type X-ray microscope 100. The imaging type X-ray microscope 100 comprises a high-brightness X-ray source 120, a condenser mirror 130, the sample holder 140, a reflecting mirror type X-ray lens unit 150 and a high-spatial resolution X-ray detector 190 (imaging unit). As each of X-ray reflecting mirror used in the condenser mirror 130 and the reflecting mirror type X-ray lens unit 150, a multilayer film is formed. Since a reflective surface formed by the multilayer film has a high reflectivity to X-rays of a specific wavelength and the numerical aperture can be increased by maintaining a high X-ray incident angle, it is possible to acquire a high-resolution X-ray enlarged image in a short time. The resolution δ of the imaging type X-ray microscope 100 can be expressed as δ=kλ/NA, using a constant k, a wavelength λ and a numerical aperture NA of X-rays to be irradiated.

Such an imaging type X-ray microscope 100 is highly useful, for example, in inspection of semiconductor devices formed with structures of several tens of nm scale finely designed and densified in a thickness of several μm. If wafer products can be observed or inspected in a non-destructive manner by the imaging type X-ray microscope 100, the productivity in device manufacturing can be greatly improved. In addition, the imaging type X-ray microscope 100 enables observation of a region having a size of 50 nm to 1 μm, for example, in the research field of life sciences. Specific examples include internal structures of organelles, cells, tissues, organs, organ systems, morphologies of model cells, disease model cells and morphologies of mutation sites of genetically modified animal. X-ray microscope makes it possible to observe CT scan tomographic images of 50 nm to 1 μm in size, and thick cells can be observed three-dimensionally without being sliced.

The X-ray irradiation unit 110 has an X-ray source 120, a condenser mirror 130 and an aperture 135 and irradiates microfocus high-power X-rays toward a sample. The X-ray source 120 is preferably a rotating anticathode type microfocus high power X-ray source. The irradiated X-rays preferably have an energy of 4 keV or more. The energy and wavelength of X-rays are inversely proportional, and the higher the energy, the shorter the wavelength. Therefore, by using X-rays with such a short wavelength, it is possible to increase the limit of the principle resolution δ of the imaging type X-ray microscope 100. As a target of the X-ray source defining the wavelength of X-rays, for example, Cr, Cu, Mo, and Ag can be provided.

The X-ray source 120 preferably generates X-rays with an output of 500 W or more, and more preferably 1 kW or more. As a result, the intensity of the irradiated X-rays can be increased. The condenser mirror 130 is optimally designed so as to focus the generated X-rays to a minute irradiation area at an convergent angle optimum to the numerical aperture of the X-ray lens. Further, for the mirror surface, a multilayer film having a high reflectivity in X-rays of the required wavelength is formed. The structure of the multilayer film is described below in detail. Incidentally, in this specification, “having a high reflectivity” means “when the intensity of the characteristic X-rays incident is referred as 100%, the intensity of the characteristic X-rays reflected per one reflection of the mirror is 70% or more”.

The aperture 135 is capable of controlling the opening of the first direction and the second direction both perpendicular to the X-ray irradiation direction and adjusts the size of each direction of the X-ray toward the sample S. In the present embodiment, the first direction represents the vertical direction, and the second direction represents the horizontal direction, but this is not necessarily in any case.

The sample holder 140 has a rotation stage capable of rotation control with high accuracy, and holds the sample S. By acquiring images while rotating the sample S in the rotation stage, it is also possible to reconstruct the stereoscopic image from the acquired images.

The reflecting mirror type X-ray lens unit 150 has a Wolter type mirror set capable of reflecting into a first direction perpendicular to the X-ray irradiation direction and a second direction perpendicular to the first direction, the X-rays transmitted through the sample S are imaged to the receiving surface of the high-spatial resolution X-ray detector 190. Thus, an enlarged image with high resolution in two dimensions can be acquired. A value obtained by dividing the distance L1 from the sample to the lens plane formed by the reflecting mirror type X-ray lens unit 150 by the distance L2 from the lens plane to the receiving surface is a magnification ratio of the X-ray image.

The “Wolter type” refers to the mirror set comprising mirrors respectively having hyperbolic and elliptical reflective surfaces. The “Wolter type” makes it possible to have a large area to be imaged. Each mirror has a reflective surface formed of a multilayer film. The multilayer film is described below in detail.

The high-spatial resolution X-ray detector 190 is, for example, a CCD camera having a receiving surface and acquires a formed X-ray image. The high-spatial resolution X-ray detector 190 preferably has a spatial resolution of 1 μm or less and may have a spatial resolution of 0.5 μm or less. Thus, data of an enlarged image can be acquired with a high resolution having a pixel size of 50 nm or less, preferably 25 nm or less. Note that the ray intensity, i.e., the brightness of the observed image, is proportional to NA²/magnification 2.

### [Focusing System and Imaging System]

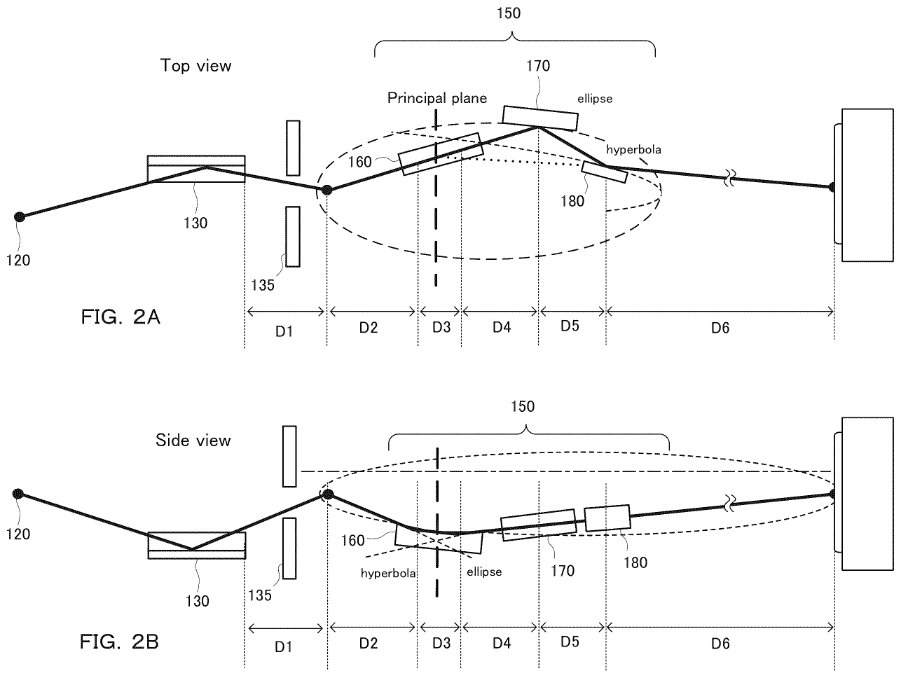

FIGS. 2A and 2B are plan and front views of the optical system of an imaging type X-ray microscope 100, respectively. As shown in FIGS. 2A and 2B, the imaging type X-ray microscope 100 comprises a condenser mirror 130.

The X-ray source 120 generates X-rays with a focus size of 100 μm or less, and the condenser mirror 130 preferably focuses the generated X-rays on an irradiated area with 100 μm (a full width at half maximum (FWHM)) or less. Furthermore, if the focus size of the X-ray source and the focal spot size at the irradiated area can be narrowed down to 50 μm (FWHM) or less, it is possible to increase output of the X-ray entering the targeted field of view. Thereby, for example, X-rays having a photon quantity 109 photons per second or more can enter an irradiated area having a diameter of 50 μm. The focus size means the size of the effective focus seen from the X-ray flux side.

It is preferable that the condenser mirror 130 has vertical and horizontal reflection surfaces formed of multilayer films and irradiates the sample S with monochromated X-rays. The X-ray incident angle to the mirror can be large by the multilayer film, and a micro focus with large X-ray intensity can be formed by a large convergent angle.

In the exemplary embodiments shown in FIGS. 2A and 2B, the reflecting mirror type X-ray lens unit 150 comprises imaging elements 160, 170 and 180 in order from the sample S side. The imaging element 160 has a mirror set composed of the first imaging mirror and the second imaging mirror in the vertical reflections. The imaging element 170 has a first imaging mirror of horizontal reflection, and the imaging element 180 has a second imaging mirror of horizontal reflection. The mirror set of horizontal reflection is constituted by the imaging element 170 and 180. The distance D1 between the second imaging mirror of the horizontal reflection and the sample S is described below.

Both the first imaging mirror and the second imaging mirror of the vertical reflection are concave mirrors. The mirror set, which is composed of these, forms a lens plane at a position overlapping the mirror set. On the other hand, the first imaging mirror of the horizontal reflection is a concave mirror, and the second imaging mirror of the horizontal reflection is a convex mirror. The mirror set, which is composed of these, forms a lens plane at the position of the front stage of the mirror set. Then, by precisely processing the reflecting surface of each mirror, it is possible to match the lens plane of the vertical reflection with the lens plane of the horizontal reflection. In the above example, though the combination of successive 3 concave mirrors and 1 convex mirror is adopted from the viewpoint of the compactness and matching the lens plane, another combination of mirrors arrangement may be adopted.

In the embodiments shown in FIGS. 2A and 2B, the respective distances D2, D3, D4, D5 and D6 obtained by dividing the distance on the optical axis from the sample S to the receiving surface at the reflection positions of the respective imaging mirrors can be set to, for example, 30 to 60 mm, 30 to 60 mm, 50 to 100 mm, 50 to 100 mm and 1 to 2.5 m. The distance D2 is called working distance, corresponds to the distance from the sample S to the first imaging mirror of the vertical reflection. A user desires to make the working distance as large as possible in arranging and measuring the sample S, but there are limitations in obtaining necessary magnification ratio and numerical aperture as described below.

In the exemplary embodiments shown in FIGS. 2A and 2B, multilayer films are formed on the reflecting surfaces of the imaging mirrors of the condenser mirror 130 and the imaging elements 160 to 180. As a result, even with high-energy X-rays, intense X-rays can not only be irradiated to the sample position at a large convergent angle, but also the numerical aperture can be increased, and a magnified image of sufficient intensity can be acquired even in a laboratory.

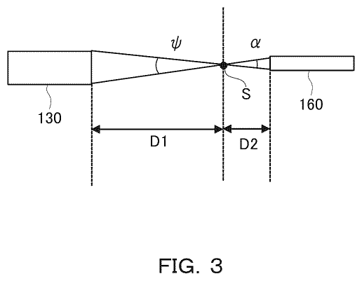

FIG. 3 is a schematic view showing a convergent angle and the capture angle. The convergent angle Ψ is the maximum angle of X-rays that enters the sample S from the condenser mirror with respect to the optical axis. The capture angle α is the maximum angle of the X-ray that enters the reflecting mirror type X-ray lens unit 150 from the sample S with respect to the optical axis, and the numerical aperture NA is sin (α/2). The convergent angle Y formed by the condenser mirror 130 and the numerical aperture NA to the reflecting mirror type X-ray lens unit 150 are determined according to each X-ray source. For example, with respect to CuKα, the convergent angle ψ is 10 mrad, and the capture angle α is 9.4 mrad, and with respect to Mokα, the convergent angle ψ is 5 mrad, and the capture angle α is 5 mrad. Thus, the position of the sample S is determined, and the relationship between the distances D1 and D2 is determined. The intensity acquired on the high-spatial resolution X-ray detector 190 for an X-ray microscope is approximately proportional to the square of the convergent angle and the capture angle. Therefore, it is desirable to take these angles as large as possible for an apparatus in a laboratory where it is difficult to prepare an intense X-ray source, and the effect of increasing the incident angle on the reflecting surface made of the multilayer film is extremely large.

### [Multilayer Film]

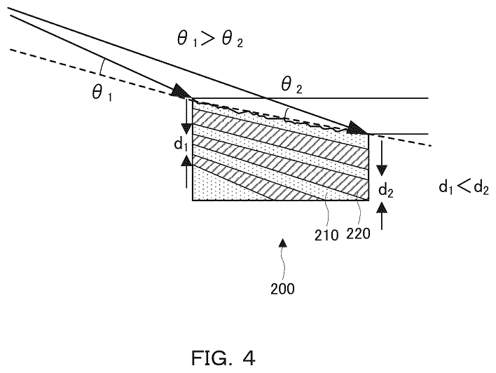

FIG. 4 is a cross-sectional view showing a multilayer film. As shown in FIG. 4, in the multilayer film, layers formed of a heavy element and layers formed of a light element are alternately stacked. In each of the multilayer films, a heavy element layer and a light element layer are repeatedly stacked as a pair of layers. The number of stacked layers may be set for each mirror constituting the mirror set.

The multilayer film selectively reflects characteristic X-rays of the corresponding wavelength out of the incident X-rays. The periodic formation of heavy and light elements produces regular graduations of the electron density, and a diffraction phenomenon occurs. If the incident X-rays contain continuous X-rays or a plurality of types of characteristic X-rays, the X-rays reflected from the multilayer mirror are a part or all of the characteristic X-rays diffracted by the multilayer film.

The multilayer spacing d is determined according to the wavelength of the characteristic X-rays and the shape of the mirror (the shape of the curved reflecting surface such as parabolic shape or elliptical shape). Therefore, the multilayer spacing is optimally designed according to the target type of the X-ray source 120 and the surface shape of the mirror.

In the example shown in FIG. 4, for the period length d1 at the position of the incident angle θ1 and the period length d2 at the position of the incident angle θ2, the relationship of d1<d2 is necessary when θ1>θ2. The thickness (period length) of each layer is designed to vary with position, and precise film formation as designed is required at the time of manufacturing.

By forming a multilayer film for the mirror surface, it becomes possible to increase the X-ray incident angle. As a result, it is possible to realize a compact focusing lens having a large convergent angle and a compact imaging lens having high numerical aperture.

The multilayer film can be formed by, for example, generating plasma and stacking particles generated by applying the plasma to a target on a substrate. At that time, it is possible to install a slit for narrowing the particles generated, by the opening shape, to adjust the amount of particles reaching the substrate, that is, the film thickness. Alternatively, by changing the speed of the substrate passing through the vicinity of the slit, the layer thickness can be made thin where the substrate has moved faster and thick where the substrate has moved slowly. By combining these methods, it is possible to form thin films with different thicknesses from place to place with high accuracy. Note that tungsten or molybdenum as the heavy element, silicon, carbon, boron or the like as the light element can be used.

The multilayer film is preferably formed with an error of 0.5 Å or less with respect to the designed periodicity, and more preferably formed with an error of 0.2 Å or less. The shape of the optical element and the nonuniformity of the periodic structure causes the disturbance in the wavefront of the X-ray. By forming a multilayer film so that the error of the periodicity on the position and the error of the surface shape are reduced with respect to the designed value, it is possible to reduce the wavefront disturbance of the X-rays reflected by the formed reflecting surface. Thus, in imaging using hard X-rays, it is possible to acquire an X-ray image with sufficiently high resolution without phase shift over the entire surface of the lens.

For example, by adopting a reflective imaging lens coated with such a multilayer film, the capture angle can be made more than 8 mrad even when using X-rays with 8 keV commonly used in the laboratory. In addition, even when 17.5 keV X-rays are used, the capture angle can be made more than 5 mrad value, and lenses having an efficacy of more than 40% can be realized.

### [Accuracy Test of Multilayer Film]

Multilayer films for respective imaging mirrors used in the imaging type X-ray microscope 100 was prepared. The multilayer film was produced by RIT (Rigak Innovative Technologies, Inc.). As a film forming apparatus used for manufacturing a multilayer film, a film forming apparatus, in which high film forming stability, reproducibility, and film thickness controllability were achieved by repeating calibration many times, was used. The period length with respect to the position for each obtained multilayer film was measured with high accuracy by X-ray reflectivity.

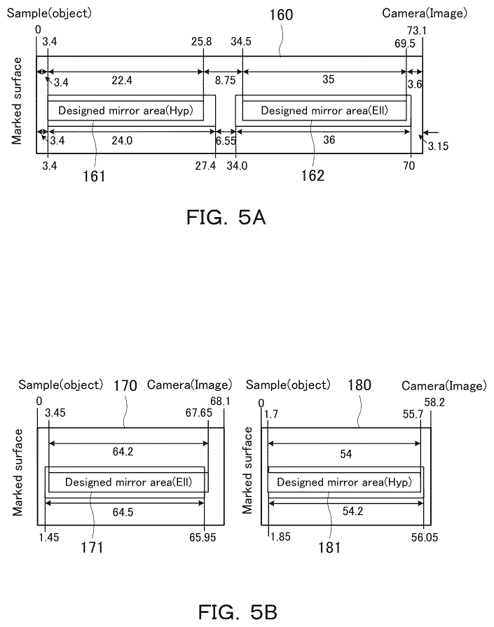

FIGS. 5A and 5B are plan views showing a mirror set of vertical reflection and a mirror set of horizontal reflection, respectively. As shown in FIG. 5A, each multilayer film of hyperbolic and elliptical surfaces was respectively formed in the first imaging mirror 161 and the second imaging mirror 162 of the imaging element 160 for vertical reflection. Further, as shown in FIG. 5B, multilayer films of ellipsoidal and hyperboloid were respectively formed in the first imaging mirror 171 and the second imaging mirror 181 of the imaging element 170 and the imaging element 180 for horizontal reflections.

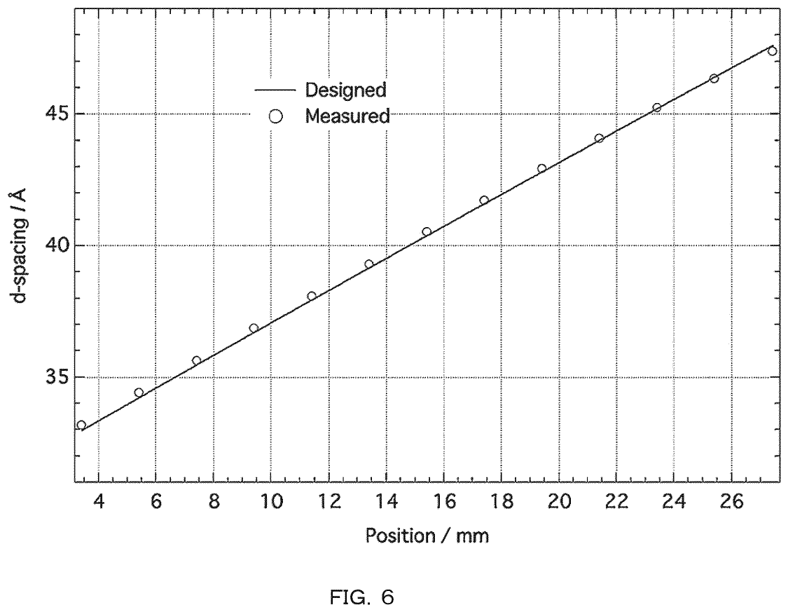

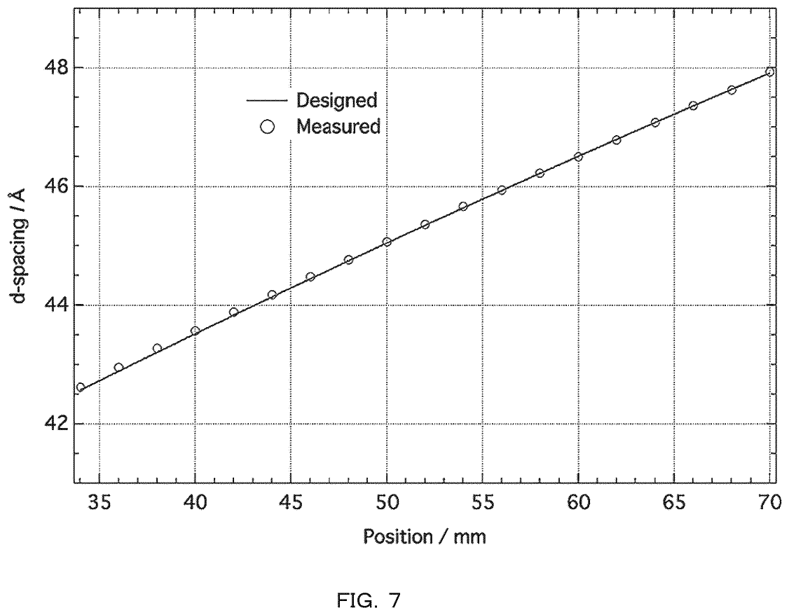

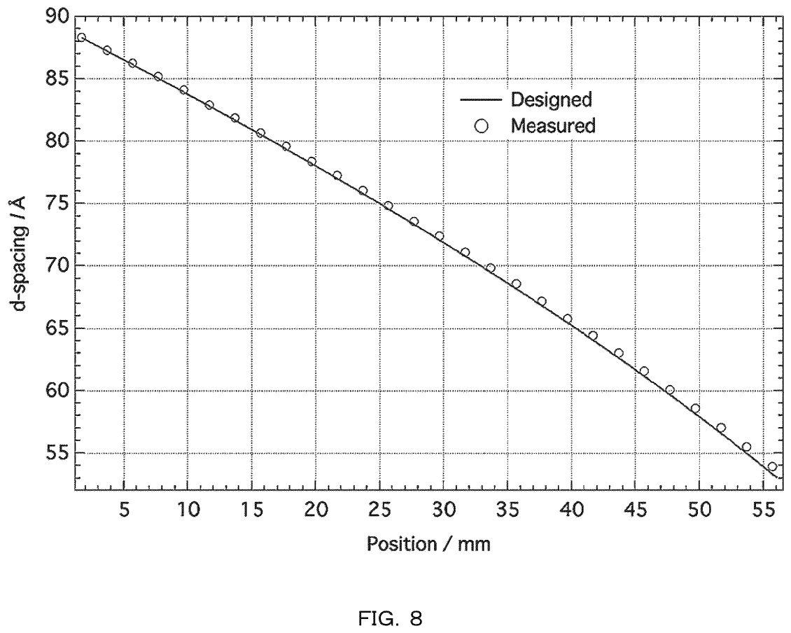

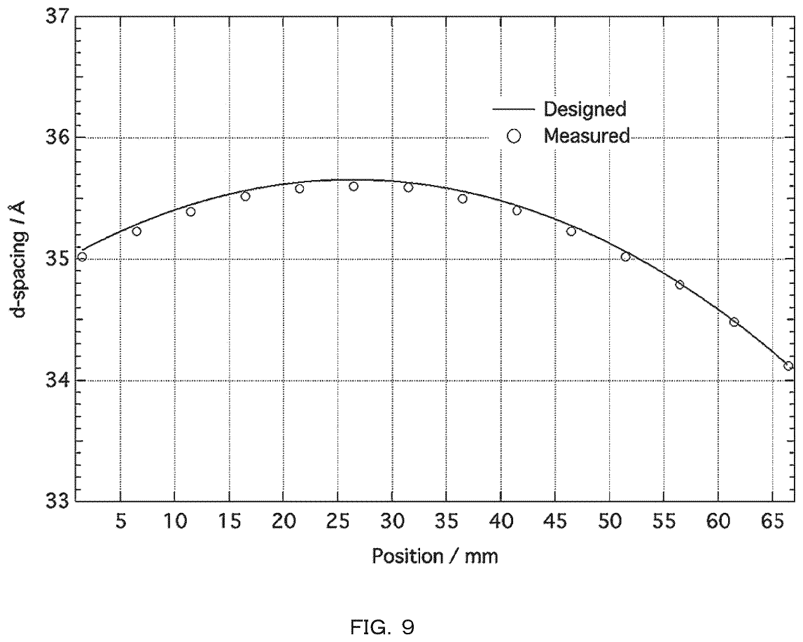

FIG. 6 is a graph showing the designed value and the measured value of the period length of the multilayer film with respect to the position of the first imaging mirror for vertical reflection. FIG. 7 is a graph showing the designed value and the measured value of the period length of the multilayer film with respect to the position of the second imaging mirror for vertical reflection. FIG. 8 is a graph showing the designed value and the measured value of the period length of the multilayer film with respect to the position of the first imaging mirror for horizontal reflection. FIG. 9 is a graph showing the designed value and the measured value of the period length of the multilayer film with respect to the position of the second imaging mirror for horizontal reflection.

In either figure, the straight line represents the designed value of the period length corresponding to the position, the circle represents the measured value of the period length for each position. With respect to the period length of the multilayer film in each of the imaging mirrors, the error was within 0.2 Å.

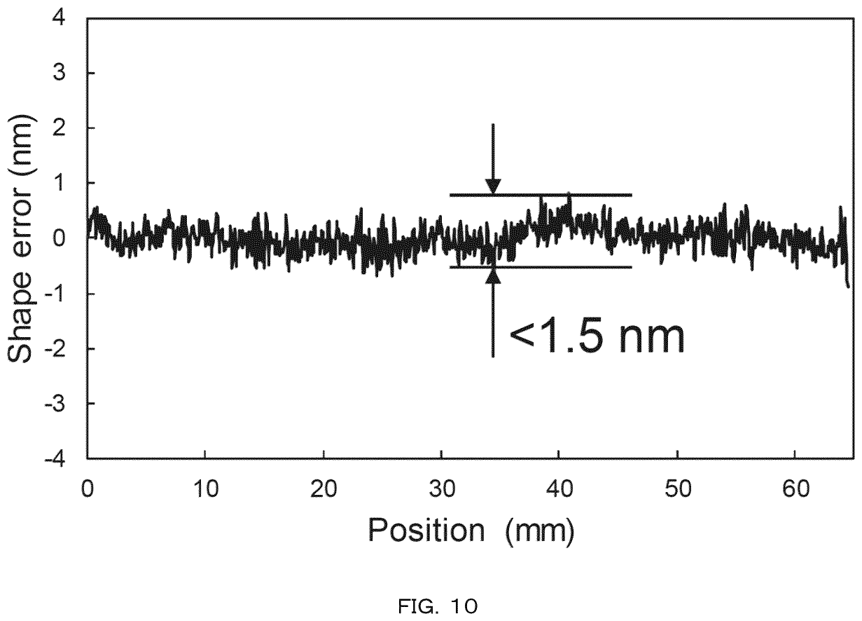

FIG. 10 is a graph showing the magnitude of the error for the surface shape with respect to the position of the second imaging mirror for horizontal reflection. As shown in FIG. 10, the error of the surface shape in the second imaging mirror for horizontal reflection was within 1.5 nm. Incidentally, the same results as the second imaging mirror for horizontal reflection were obtained for the surface shape of the other mirrors.

### [Resolution Evaluation of X-ray Image]

The imaging type X-ray microscope 100 was assembled using the mirror manufactured with the above-described accuracy of the multilayer film. An X-ray source of CuKα was used. Specifications of the details of the mirror set constituting the reflecting mirror type X-ray lens unit 150 are as shown in the following table.

TABLE 1

| | VERTICAL REFLECTION | | HORIZONTAL REFLECTION | |
|---|---|---|---|---|
| | MIRROR SET | | MIRROR SET | |
| | HYPERBOLIC | ELLIPTICAL | ELLIPTICAL | HYPERBOLIC |
| SHAPE | CONCAVE | CONCAVE | CONCAVE | CONVEX |
| MIRROR LENGTH (mm) | 22.4 | 35.0 | 64.2 | 54.0 |
| DIAGONAL INCIDENT | 17.0 | 19.34 | 21.6 | 10.6 |
| ANGLE (mrad) | | | | |
| NUMERICAL APERTURE | 4.74 × 10⁻³ | | 4.83 × 10⁻³ | |
| FIELD OF VIEW (μm) | 13.5 | | 36 | |
| MAGNIFICATION RATIO | 32 | | 31 | |
| N NUMBER OF | 75 | 75 | 100 | 40 |
| W/Si MULTILAYER FILM | | | | |

| | |
|---|---|
| REFLECTIVITY | 75~80% (PER REFLECTION) |

For the high-spatial resolution X-ray detector 190, a high-resolution X-ray camera XsightXRM manufactured by Rigaku was used. As a sample, an X-ray image of a test chart for resolution evaluation was acquired. As test charts for resolution evaluation, X-ray charts of thick film high-resolution types made by NTT-AT (XRESO-50HC, smallest dimension of 50 nm, pattern height of 500 nm) were used. The pixel resolution of the calculated X-ray image was 12 nm. The relationship between the magnification of the reflecting mirror type X-ray lens unit 150, the spatial resolution of the high-spatial resolution X-ray detector 190, and the pixel resolution of the X-ray image is as shown in Table 2 below.

TABLE 2

| MAGNIFICATION | SPATIAL | |
|---|---|---|
| RATIO OF | RESOLUTION OF | PIXEL |
| IMAGING SYSTEM | DETECTING SYSTEM | RESOLUTION |
| (TIMES) | (μm/pixel) | (μm/pixel) |
| M | A | B = A/M |

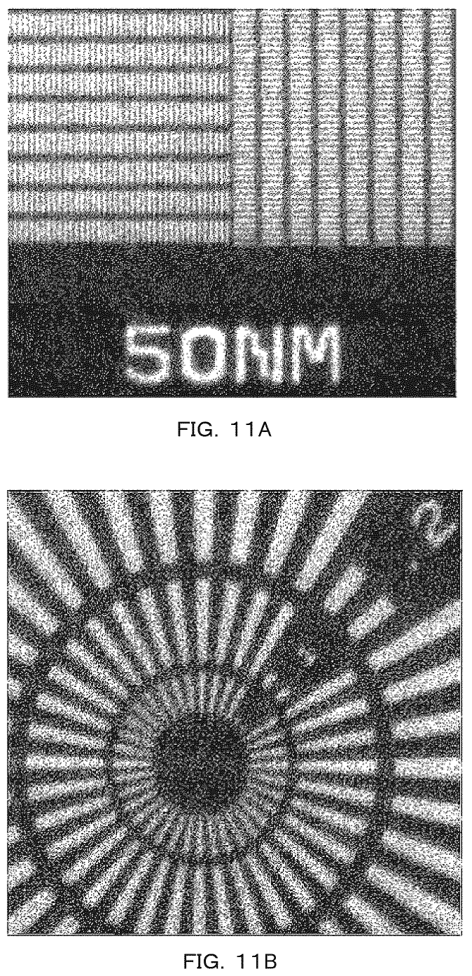

FIG. 11A is a diagram showing an X-ray image of a test chart having a 50 nm linewidth for evaluating resolution. FIG. 11B is a diagram showing an X-ray image of a star chart having a 50 nm center line width for evaluating resolution. In all X-ray images, 50 nm charts can be distinguished, providing adequate resolution for inspecting the microstructure of semiconductor devices.

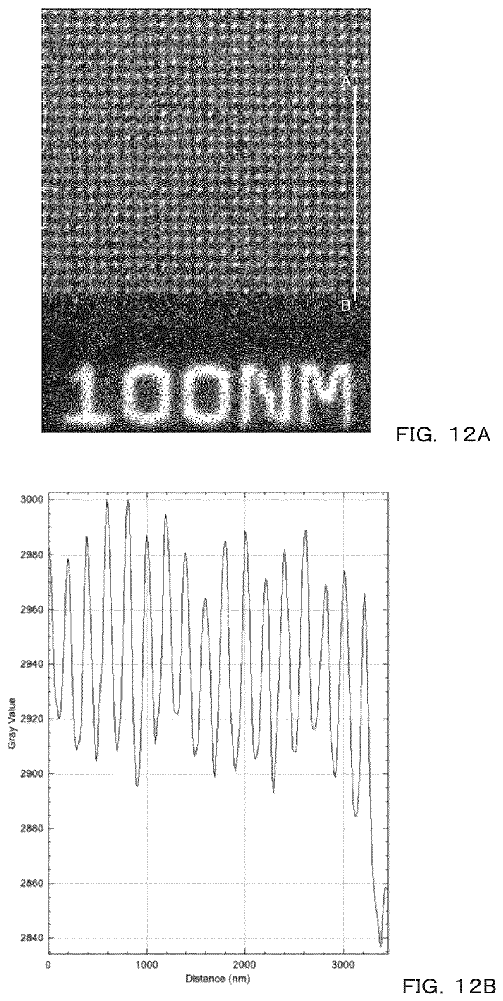

FIGS. 12A and 12B are diagrams showing the X-ray image of 100 nm hole chart and the intensity profile of a part thereof (line profile), respectively. As shown in the diagrams, it was confirmed that the holes with the diameter of 100 nm are regularly arranged at 200 nm intervals and each of the holes has a minute difference.

### [Semiconductor Inspection Apparatus]

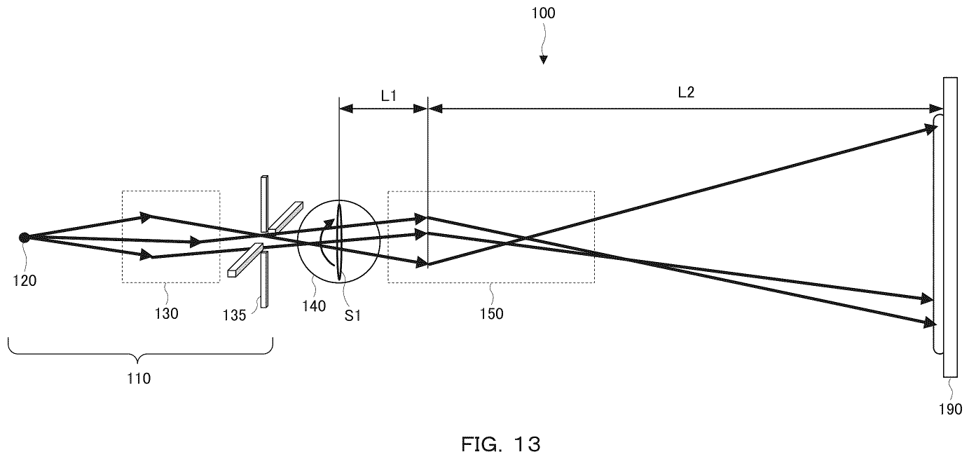

A semiconductor inspection apparatus to which the above-described imaging type X-ray microscope 100 is applied is described below. FIG. 13 is a schematic view showing an application example of the imaging type X-ray microscope 100 to a semiconductor inspection apparatus. The basic configuration of the imaging type X-ray microscope 100 shown in FIG. 13 is the same as that shown in FIG. 1. However, depending on the configuration according to the characteristics of the sample S1 and the situation peculiar to the inspection process, a configuration that is further suitable as the semiconductor inspection apparatus can be adopted. Note that the semiconductor inspection apparatus can be used not only for the purpose of quality inspection in an inspection process of a manufactured semiconductor, but also for the purpose of inspection in a laboratory at the time of research and development.

The imaging type X-ray microscope 100 has a high resolution of 100 nm or less, preferably 50 nm or less, and can be applied to a process of inspecting whether or not a microstructure of a semiconductor is defective. Since the imaging type X-ray microscope 100 can irradiate X-rays of 15 keV or more with the X-ray source 120, the X-ray image can be acquired by transmitting the X-ray through the silicon substrate. In particular, from the viewpoint of ease of construction, it is preferable to use 17.5 keV MoKα. As a result, a structure buried at a depth of 10 μm or more from the surface of the semiconductor sample can be observed. In addition, since the absorption coefficient at each position can be measured by the transmittance of X-rays, the amount of the material introduced into each hole can be measured by, for example, CVD method or the like, and the effect of CVD method or the like can be quantitatively evaluated. Further, it is possible to directly observe a structure such as a shape representing a size of a deep hole or a groove of a portion not visible from the surface and a variation in the arrangement thereof.

The sample S1 in the semiconductor inspecting step is a silicon wafer formed in a flat plate shape (for example, diameter 300 mm). Therefore, in the case of CT imaging, it is also assumed that it can be difficult to rotate by 360°. In such cases, the sample S1 needs to be rotated within a limited range. For example, the sample S1 can be rotated within +5° or more, and the wafer sample can be tilted and measured. As a result, it is possible to observe the structural change depending on the depth.

It is known that the size of the entire device installed at the manufacturing and testing site is not problematic if it is empirically less than 4 m. When the imaging type X-ray microscope 100 is applied to a semiconductor inspection apparatus, it is preferable that the distance on the optical axis from the sample S1 to the receiving surface of the high-spatial resolution X-ray detector 190 is 3 m or less. Thus, a compact semiconductor inspection apparatus can be constructed. Then, it can be stored in a limited storage space of the inspection room, it becomes easy to incorporate in the existing inspection process.

In addition, it is preferable that a capture angle of the reflecting mirror type X-ray lens unit 150 is 5 mrad or more. As a result, the length from the sample S1 to the receiving surface of the high-spatial resolution X-ray detector 190 can be shortened, and a compact semiconductor inspection apparatus can be realized.

### [Semiconductor Inspection System]

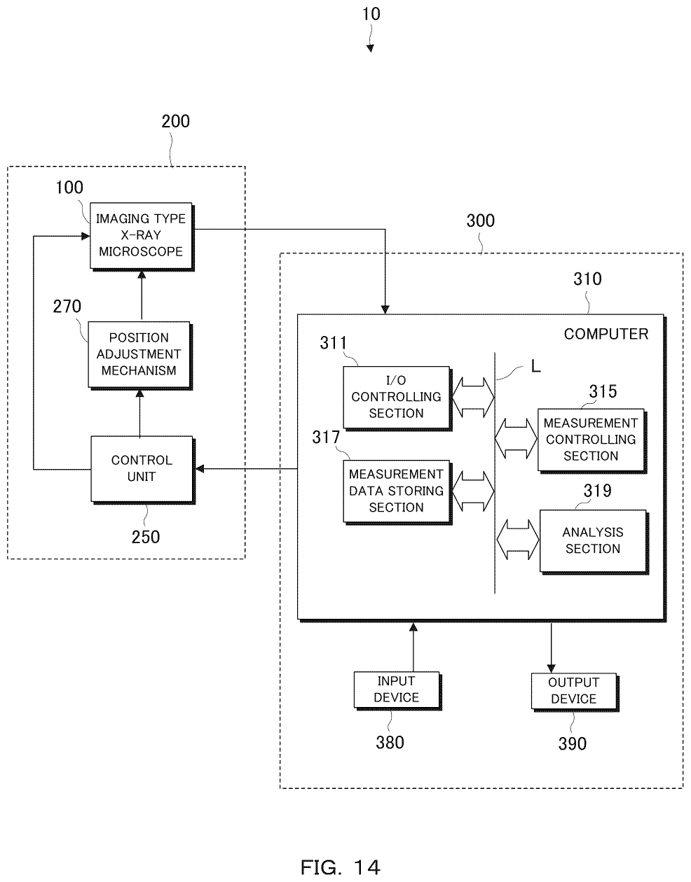

FIG. 14 is a block diagram showing the semiconductor inspection system 10. The semiconductor inspection system 10 comprises a semiconductor inspection apparatus 200 and a processing apparatus 300. The processing apparatus 300 functions as a control apparatus that controls the operation of the semiconductor inspection apparatus 200 or an analysis apparatus for measurement data obtained from the semiconductor inspection apparatus 200. In the example shown in FIG. 14, the semiconductor inspection system 10 comprises a plurality of apparatuses, but the functions of the apparatuses may be aggregated and configured as a single apparatus.

### (Semiconductor Inspection Apparatus)

The semiconductor inspection apparatus 200 comprises an imaging type X-ray microscope 100, a control unit 250, and a position adjustment mechanism 270. The imaging type X-ray microscope 100 is configured as described above, and each of the mirrors constituting the condenser mirror 130 and the reflecting mirror type X-ray lens unit 150 has a reflecting surface in which a multilayer film having a high reflectivity in X-rays of a specific wavelength is formed. As a result, even with high-energy X-rays, it is possible to increase the numerical aperture by keeping the X-ray incident angle high, it is possible to obtain a magnified image with sufficient intensity with a size that can be stored in the laboratory. As a result, the local microstructure inside the semiconductor can be inspected non-destructively.

The control unit 250 and the position adjustment mechanism 270 allow for accurate alignment. The control unit 250 controls the operation of the imaging type X-ray microscope 100 in response to a control instruction from the processing apparatus 300.

For example, the control unit 250 adjusts the position of the sample S1 relative to each part in the imaging type X-ray microscope 100 by the position adjustment mechanism 270. For respective units, an X-ray irradiation unit 110, an X-ray source 120, a condenser mirror 130, a diaphragm 135, a reflecting mirror type X-ray lens unit 150, imaging elements 160 to 180, and a high-spatial resolution X-ray detector 190, which enable focus alignment and sample alignment, are provided. The control unit 250 can also change the voltage supplied to the X-ray irradiation unit 110 to change the X-ray intensity.

The position adjustment mechanism 270 is a mechanism that allows the relative position of the sample S1 with respect to each part of the imaging type X-ray microscope 100 to be adjusted by autonomous or operation-based control. For specific examples, it includes a sample adjustment mechanism by a sample stage, a measurement position movement (alignment) and a focus position tuning mechanism. With this mechanism, for example, the sample position can be moved closer to or farther away from the high-spatial resolution X-ray detector 190 on the optical axis. The position adjustment mechanism 270 can rotate the rotation stage. Note that the configuration shown in FIG. 14 is an example, and a configuration in which the operation of the imaging type X-ray microscope 100 is manually adjusted without the control unit 250 or the position adjustment mechanism 270 may be adopted.

### (Processing Apparatus)

The processing apparatus 300 controls the operation of the imaging type X-ray microscope 100 as a control apparatus, acquires an X-ray image, and analyzes the acquired X-ray image as an analysis apparatus. The functions of the processing apparatus 300 are mainly realized by the computer 310.

The computer 310 is, for example, a PC, and comprises a processor that executes processes, a memory that stores programs and data, a hard disk or the like. The computer 310 is connected to an input device 380 such as a keyboard and a mouse, and an output device 390 such as a display, receives an input of a user from the input device 380, and outputs an input screen, an X-ray image, a graph, an analysis result or the like to the output device 390.

The computer 310 may be a server device placed on a cloud. In addition, from the viewpoint of processing burden, the function of controlling the operation of the imaging type X-ray microscope 100 and the function of analyzing the measured data may be separated, and the control may be executed by a PC installed in the site, and the analysis may be executed by the server device.

The computer 310 comprises an I/O controlling section 311, a measurement controlling section 315, a measurement data storing section 317, and an analysis section 319. Each section can transmit and receive information via the control bus L.

The I/O controlling section 311 receives an input from the input device 380 and controls an output to the output device 390. The I/O controlling section 311 can receive an input of a measurement condition, for example. Examples of the measurement conditions include the intensity of the generated X-ray, the irradiation position of the X-ray, the position of the sample, the arrangement of the detector and the measurement time at the time of acquiring the X-ray image. Further, the I/O controlling section 311 can output the obtained X-ray image and analysis result.

The measurement controlling section 315 controls an operation for measurement by the imaging type X-ray microscope 100. The controlled operations include placement of each part, adjustment of the relative position of the sample and generation of x-rays. The control instruction is transmitted to the control unit 250 in the semiconductor inspection apparatus 200, and thus each unit of the imaging type X-ray microscope 100 is controlled.

The measurement data storing section 317 stores an X-ray image acquired by the imaging type X-ray microscope 100 as measurement data. The stored measurement data can be used for screen display for observation of an X-ray image and analysis of data.

The analysis section 319 analyzes the obtained measurement data. For example, the analysis section 319 quantitatively evaluates the surface density of the substance based on the absorption coefficient at each position. In addition, the presence or absence of a defect in the sample can be determined based on the quantitative evaluation. The analysis section 319 can also evaluate the depth of the hole inside the semiconductor and the state of the substance deposited by CVD method.

### (Sample)

The sample S1 has a substrate that forms a semiconductor circuit. In particular, the semiconductor inspection apparatus 200 is extremely useful for inspecting a semiconductor with structures tens of nanometers wide and micrometers deep. Further, even when the sample S1 comprises a semiconductor device layer provided on the substrate, it is effective in that the microstructure of the interior can be measured in a non-destructive. The semiconductor device layer may be formed of various metals or silicon compounds, for example.

In addition, when the sample S1 is a plate-like member having a thickness of 500 micrometers or more, the semiconductor inspection apparatus 200 is effective. By using the semiconductor inspection apparatus 200, an enlarged image of sufficient intensity can be obtained, and inspection can be performed.

### [Semiconductor Inspection Method]

Semiconductor inspection can be performed non-destructively using the semiconductor inspection system 10 as described above. In this case, the sample is first placed in the sample holder 140. It is preferable to install the sample by an automatic conveying device such as a robot arm or a belt conveyor from the viewpoint of efficiency improvement, but it can be performed manually. In addition, the placement of the sample means either or both of fixing the sample of the semiconductor to the sample stage and aligning the sample of the semiconductor on the sample stage with the X-ray irradiation position. Next, the sample S1 is irradiated with X-rays of 15 keV or more. Then, the presence or absence of defects in the sample is evaluated with the imaged X-ray image. In this way, it is possible to inspect the microstructure inside the semiconductor locally by obtaining a magnified image with sufficient intensity with a size that can be stored in the laboratory. Note that the evaluation includes that the user visually evaluates the X-ray image.

### Example

The scale parallel to the surface of a semiconductor device having deep holes is on the order of several tens of nm to several hundred nm. The images of the X-ray charts shown in FIG. 11 and FIG. 12 demonstrate that the X-ray microscope of the present invention clearly enables distinguishing each structure of line-width 50 nm or every single 100 nm hole. In addition, as shown in the intensity charts of FIG. 12B, it was confirmed that the respective holes had subtle differences.

This application claims priority from Japanese Patent Application No. 2022-071044, filed on Apr. 22, 2022, the entire contents of Japanese Patent Application No. 2022-071044 are incorporated herein by reference.

### DESCRIPTION OF SYMBOLS

10 semiconductor inspection system
100 imaging type X-ray microscope
110 X-ray irradiation unit
120 X-ray source
130 condenser mirror
135 aperture
140 sample holder
150 reflecting mirror type X-ray lens section
160 to 180 imaging element
190 high-spatial resolution X-ray detector (imaging unit)
200 semiconductor inspection apparatus
250 control unit
270 position adjustment mechanism
300 process apparatus
310 computer
311 I/O controlling section
315 measurement controlling section
317 measurement data storing section
319 analysis section
380 input device
390 output device
L control bus
D1-D6 distance
L1, L2 distance
S, S1 sample
d1, d2 period length

1. A semiconductor inspection apparatus using an enlarged X-ray image, comprising:
an X-ray source having a micro focus and high output,
an X-ray irradiation unit having a condenser mirror for condensing, the X-ray irradiation unit irradiating emitted X-rays toward a sample of semiconductor,
a sample holder for holding the sample,
a reflecting mirror type X-ray lens unit for forming an image with an X-ray transmitted through the sample, and
an X-ray detector for acquiring the formed X-ray image, wherein
each mirror constituting the condenser mirror and the reflecting mirror type X-ray lens unit has a reflective surface that is formed of a multilayer film having a high reflectivity for X-rays with a specific wavelength.

2. The semiconductor inspection apparatus according to claim 1, wherein
the sample includes a substrate forming a semiconductor circuit and a semiconductor device layer provided on the substrate.

3. The semiconductor inspection apparatus according to claim 1, wherein
the sample is a plate-like body having a thickness of 500 μm or more.

4. The semiconductor inspection apparatus according to claim 1, wherein
a distance on an optical axis from the sample to a receiving surface of the imaging unit is 3 m or less.

5. The semiconductor inspection apparatus according to claim 1, wherein
a capture angle by the reflecting mirror type X-ray lens unit is 5 mrad or more.

6. The semiconductor inspection apparatus according to claim 1, further comprising
a position adjustment mechanism capable of adjusting a relative position of the sample with respect to each unit under automatic or operation-based control.

7. A semiconductor inspection system, comprising:
the semiconductor inspection apparatus according to claim 1, and
a controller connected to the semiconductor inspection apparatus, wherein
the controller, automatically or based on an instruction from a user, adjusts a relative position of the sample with respect to each unit in the semiconductor inspection apparatus.

8. A semiconductor inspection system, comprising:
the semiconductor inspection apparatus according to claim 1, and
an analysis apparatus connected to the semiconductor inspection apparatus, wherein the analysis apparatus includes processing circuitry configured to
evaluate surface density of substance at each position based on an absorption coefficient in an X-ray image acquired by the semiconductor inspection apparatus.

9. A semiconductor inspection system, comprising:
the semiconductor inspection apparatus according to claim 1, and
an analysis apparatus connected to the semiconductor inspection apparatus, wherein the analysis apparatus includes processing circuitry configured to
evaluate a structure of a hole formed in the sample based on an absorption coefficient in an X-ray image acquired by the semiconductor inspection apparatus.

10. The semiconductor inspection system according to claim 9, wherein
the X-ray image is measured by tilting the sample.

11. A semiconductor inspection method performed non-destructively using the semiconductor inspection apparatus according to claim 1, comprising the steps of:
placing the sample in the sample holder;
irradiating the sample with an X-ray with 15 keV or more; and
evaluating the presence or absence of a defect in the sample by the formed X-ray image.

12. The semiconductor inspection apparatus according to claim 1, wherein the X-ray detector is a high-spatial resolution X-ray detector.
